(19) United States
(12) Patent Application Publication
(10) Pub. No.: US 2026/0246386 A1
(43) Pub. Date: Aug. 20, 2026

(54) INTERLEAVED BUCK-BOOST POWER FACTOR CORRECTION CIRCUIT

(71) Applicant: Delta Electronics, Inc., Taoyuan City (TW)

(72) Inventors: Ching-Ho Chou, Taoyuan City (TW); Yung-Chuan Lu, Taoyuan City (TW); Ming-Lung Hsieh, Taoyuan City (TW)

(21) Appl. No.: 19/053,819

(22) Filed: Feb. 14, 2025

(51) Int. Cl. H02M 3/158; H02M 1/00; H02M 1/42

(52) U.S. Cl. CPC H02M 3/1582; H02M 1/0009; H02M 1/0043; H02M 1/0064; H02M 1/4208

(57) ABSTRACT

An interleaved buck-boost PFC circuit is provided. The interleaved buck-boost PFC circuit includes a rectifier module, two converter circuits, a PWM controller and a high-voltage driver. The rectifier module is configured to receive an AC input voltage. The converter circuits are electrically connected in parallel between the rectifier module and an output port of the interleaved buck-boost PFC circuit, and a DC output voltage at the output port is lower than a peak value of the AC input voltage. For each converter circuit, the PWM controller provides a first control signal to the first switch through the high-voltage driver and provides a second control signal to the second switch directly. The first switch and the second switch in each converter circuit are turned on and off simultaneously, and two first control signals of two first switches of the two converter circuits interleave at least partially.

### FIELD OF THE INVENTION

The present disclosure relates to a PFC (power factor correction) circuit, and more particularly to an interleaved buck-boost PFC circuit.

### BACKGROUND OF THE INVENTION

In high-power applications, such as power systems exceeding 500 W, commonly used PFC converters include interleaved boost PFC converters. Interleaved boost power factor correction (PFC) converters become the topology of choice for high-power applications because of their ability to improve efficiency by equalizing the load current. By sharing the load current across multiple balanced phases, the RMS (root mean square) current stress, current ripple, and boost inductance of each phase can be significantly reduced. However, the interleaved boost PFC converter still has some limitations in practical applications. In high input voltage applications, such as 480 Vac power systems, the output DC bus voltage of the interleaved boost PFC converter is typically designed to 780 Vdc, which presents challenges for component selection in subsequent stages. Due to the high output voltage, the subsequent stages must use switching devices with a high withstand voltage (e.g., 900V), which are more expensive and thus increase the overall cost of the system.

To reduce costs and improve system accessibility, an interleaved buck-boost PFC converter may be considered. Usually, the output voltage of the interleaved buck-boost PFC converter is 400 Vdc, which is significantly lower than the 780Vdc of the interleaved boost PFC converter. With this lower output voltage, the subsequent circuits only require switching devices with a withstand voltage of 600V, which are standard components with lower costs and high efficiency. As a result, the system cost can be reduced. However, since the interleaved buck-boost PFC converter requires switching between different operating modes (buck mode and boost mode), the conventional control method typically utilizes microcontrollers for digital control, which would increase the structural complexity and cost.

### SUMMARY OF THE INVENTION

The present disclosure provides an interleaved buck-boost PFC circuit in order to overcome the drawbacks of the conventional technologies. In the interleaved buck-boost PFC circuit of the present disclosure, the circuit topology and control architecture are simple, thereby reducing costs and making the interleaved buck-boost PFC circuit easy to implement.

In accordance with an aspect of the present disclosure, an interleaved buck-boost PFC circuit is provided. The interleaved buck-boost PFC circuit includes a rectifier module, two converter circuits, a PWM controller and a high-voltage driver. The rectifier module is configured to receive an AC input voltage. The converter circuits are electrically connected in parallel between the rectifier module and an output port of the interleaved buck-boost PFC circuit, and a DC output voltage at the output port is lower than a peak value of the AC input voltage. Each converter circuit includes a first switch, a first diode, a second switch, a second diode and an inductor. The first switch and the first diode are electrically connected in series and coupled to the rectifier module. The second switch and the second diode are electrically connected in series and coupled to the output port. The first diode and the second switch are further coupled to a ground terminal. The inductor is electrically connected between a connection node of the first switch and the first diode and a connection node of the second switch and the second diode. For each converter circuit, the PWM controller provides a first control signal to the first switch through the high-voltage driver and provides a second control signal to the second switch directly. The first switch and the second switch in each converter circuit are turned on and off simultaneously, and two first control signals of two first switches of the two converter circuits interleave at least partially.

### BRIEF DESCRIPTION OF THE DRAWINGS

FIG. 1 is a schematic circuit diagram illustrating an interleaved buck-boost PFC circuit according to an embodiment of the present disclosure;

FIG. 2 schematically shows an implementation of the first and second control signals of the first switch and the second switch in one converter circuit;

FIG. 3 schematically shows waveforms of the AC input voltage, the DC output voltage, and an inductor current flowing through the inductor of one converter circuit under the implementation of the first and second control signals of the first switch and the second switch shown in FIG. 2;

FIG. 4 is a schematic circuit diagram illustrating an interleaved buck-boost PFC circuit according to another embodiment of the present disclosure;

FIG. 5 is a schematic perspective view illustrating the inductors of the two converter circuits of FIG. 1; and

FIG. 6 schematically shows the structure of a component of the magnetic core of FIG. 5.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only.

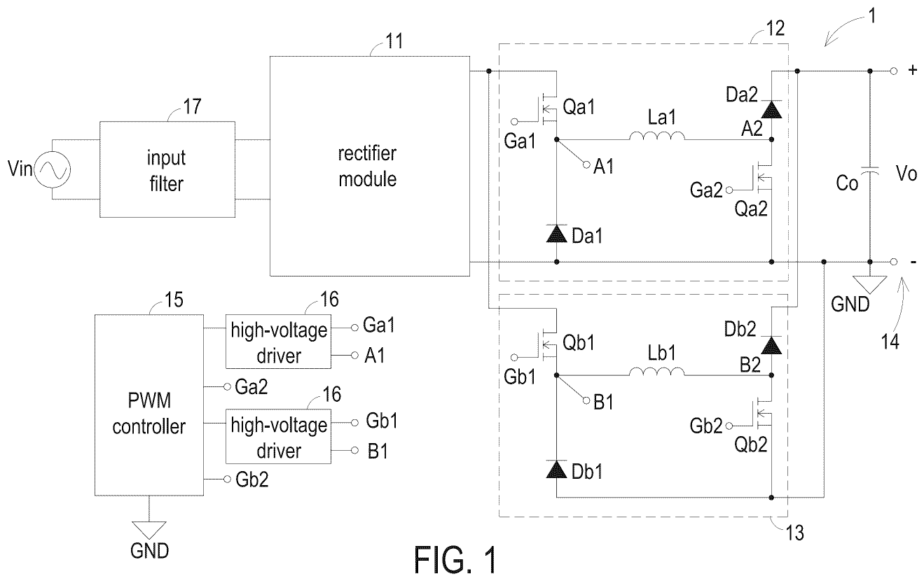

Please refer to FIG. 1. FIG. 1 is a schematic circuit diagram illustrating an interleaved buck-boost PFC circuit according to an embodiment of the present disclosure. In the present disclosure, as shown in FIG. 1, the interleaved buck-boost PFC circuit 1 includes a rectifier module 11, two converter circuits 12 and 13, an output port 14, a PWM (pulse width modulation) controller 15 and a high-voltage driver 16. The rectifier module 11 is configured to receive an AC input voltage Vin. The interleaved buck-boost PFC circuit 1 is suitable for high-input-voltage applications. For example, the AC input voltage Vin is higher than 300 Vac. At the output port 14, a DC output voltage Vo of the interleaved buck-boost PFC circuit 1 is lower than a peak value of the AC input voltage Vin. In an embodiment, the interleaved buck-boost PFC circuit 1 further includes an input filter 17 coupled to the rectifier module 11 and configured to filter the AC input voltage Vin. Namely, the rectifier module 11 receives the AC input voltage Vin filtered by the input filter 17. The specific topologies of the rectifier module 11 and the input filter 17 may be determined according to actual requirements and are not limited in the present disclosure. In addition, in an embodiment, the interleaved buck-boost PFC circuit 1 further includes an output capacitor Co, and two terminals of the output capacitor Co are electrically connected to the positive and negative terminals of the output port 14 respectively.

The two converter circuits 12 and 13 are electrically connected in parallel between the rectifier module 11 and the output port 14. The converter circuit 12 includes a first switch Qa1, a first diode Da1, a second switch Qa2, a second diode Da2, and an inductor La1. The first switch Qa1 and the first diode Da1 are electrically connected in series and coupled to the rectifier module 11. The second switch Qa2 and the second diode Da2 are electrically connected in series and coupled to the output port 14. Moreover, the first diode Da1 and the second switch Qa2 are further coupled to a ground terminal GND and a negative terminal of the output port 14. The inductor La1 is electrically connected between a connection node A1 of the first switch Qa1 and the first diode Da1 and a connection node A2 of the second switch Qa2 and the second diode Da2. Further, cathode and anode terminals of the first diode Da1 are coupled to the connection node A1 and the ground terminal GND respectively, and cathode and anode terminals of the second diode Da2 are coupled to a positive terminal of the output port 14 and the connection node A2 respectively. In an embodiment, the converter circuit 12 is a buck-boost converter, where the first switch Qa1, the first diode Da1 and the inductor La1 form a buck configuration, and the second diode Da2, the second switch Qa2 and the inductor La1 form a boost configuration.

Similarly, the converter circuit 13 includes a first switch Qb1, a first diode Db1, a second switch Qb2, a second diode Db2, and an inductor Lb1. The first switch Qb1 and the first diode Db1 are electrically connected in series and coupled to the rectifier module 11. The second switch Qb2 and the second diode Db2 are electrically connected in series and coupled to the output port 14. Moreover, the first diode Db1 and the second switch Qb2 are further coupled to the ground terminal GND and the negative terminal of the output port 14. The inductor Lb1 is electrically connected between a connection node B1 of the first switch Qb1 and the first diode Db1 and a connection node B2 of the second switch Qb2 and the second diode Db2. Further, cathode and anode terminals of the first diode Db1 are coupled to the connection node B1 and the ground terminal GND respectively, and cathode and anode terminals of the second diode Db2 are coupled to the positive terminal of the output port 14 and the connection node B2 respectively. In an embodiment, the converter circuit 13 is a buck-boost converter, where the first switch Qb1, the first diode Db1 and the inductor Lb1 form a buck configuration, and the second diode Db2, the second switch Qb2 and the inductor Lb1 form a boost configuration.

The PWM controller 15 and the high-voltage driver 16 are configured to provide control signals for the switches of the two converter circuits 12 and 13. Specifically, for the converter circuit 12, the PWM controller 15 provides a first control signal to the first switch Qa1 through the high-voltage driver 16, and the PWM controller 15 provides a second control signal to the second switch Qa2 directly. In an embodiment, the first switch Qa1 and the second switch Qa2 are MOSFETs (metal-oxide-semiconductor field-effect transistors), the higher-voltage driver 16 is coupled to the connection node A1 (i.e., source terminal of the first switch Qa1) and a gate terminal Ga1 of the first switch Qa1 to provide the first control signal for the first switch Qa1, and the PWM controller 15 is coupled to a gate terminal Ga2 of the second switch Qa2 to provide the second control signal for the second switch Qa2. Similarly, for the converter circuit 13, the PWM controller 15 provides a first control signal to the first switch Qb1 through the high-voltage driver 16, and the PWM controller 15 provides a second control signal to the second switch Qb2 directly. In an embodiment, the first switch Qb1 and the second switch Qb2 are MOSFETs, the higher-voltage driver 16 is coupled to the connection node B1 (i.e., source terminal of the first switch Qb1) and a gate terminal Gb1 of the first switch Qb1 to provide the first control signal for the first switch Qb1, and the PWM controller 15 is coupled to a gate terminal Gb2 of the second switch Qb2 to provide the second control signal for the second switch Qb2. For instance, the PWM controller 15 may include a PWM IC (integrated circuit). The high-voltage driver 16 may include a high-voltage driving IC and provide voltage isolation.

In this embodiment, the switches in each converter circuit are switched simultaneously. Specifically, the first switch Qa1 and the second switch Qa2 in the converter circuit 12 are turned on and off simultaneously in buck and boost mode, and the first switch Qb1 and the second switch Qb2 in the converter circuit 13 are turned on and off simultaneously in buck and boost mode. In addition, two first control signals of the two first switches Qa1 and Qb1 interleave at least partially. Namely, the two first switches Qa1 and Qb1 turns on alternately, and at least a part of the turn-on time of the first switches Qa1 does not overlap with that of the first switch Qb1. In an embodiment, the two first control signals of the two first switches Qa1 and Qb1 are complementary to each other. In another embodiment, the two first control signals of the two first switches Qa1 and Qb1 may have a phase difference in a range of 45 degrees to 135 degrees. In addition, in an embodiment, voltage values of the two first control signals are the same. In an embodiment, in each of the two converter circuits 12 and 13, voltage values of the first control signal and the second control signal are the same, and a phase difference between the first control signal and the second control signal is 180 degrees.

Accordingly, in the interleaved buck-boost PFC circuit 1 of the present disclosure, the circuit topology and control architecture are simple, thereby reducing costs and making the interleaved buck-boost PFC circuit 1 easy to implement. Moreover, the low output voltage, resulting from the interleaving characteristics, allows the subsequent circuits to adopt switching devices with regular withstand voltage (e.g., 600V), thereby reducing costs and achieving high efficiency.

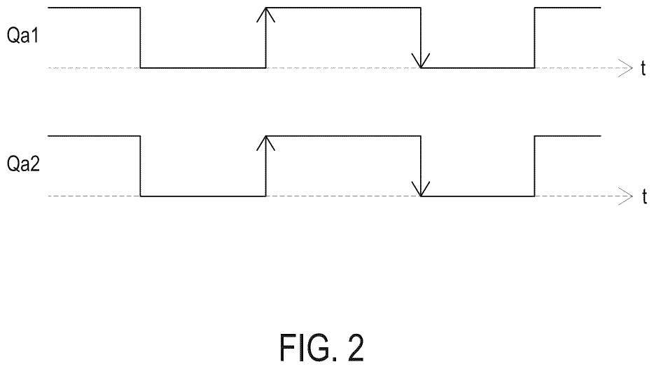

Taking the converter circuit 12 as an example, FIG. 2 schematically shows an implementation of the first and second control signals of the first switch Qa1 and the second switch Qa2 in the converter circuit 12. In FIG. 2, Qa1 and Qa2 represent the first and second control signals of the first switch Qa1 and the second switch Qa2 respectively. As shown in FIG. 2, the first switch Qa1 and the second switch Qa2 are turned on and off simultaneously.

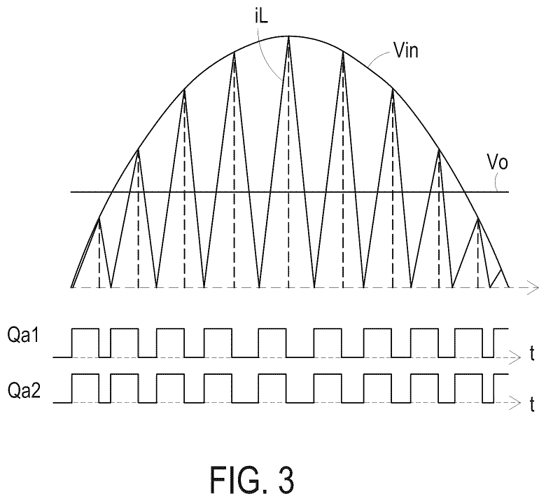

Please refer to FIG. 3. FIG. 3 schematically shows waveforms o the AC input voltage Vin, the DC output voltage Vo, and an inductor current iL flowing through the inductor La1 of converter circuit 12 under the implementation of the first and second control signals of the first switch Qa1 and the second switch Qa2 shown in FIG. 2. As shown in FIG. 3, the inductor current iL increases when the first switch Qa1 and the second switch Qa2 turn on simultaneously, and conversely, the inductor current iL decreases when the first switch Qa1 and the second switch Qa2 turn off simultaneously. Further, the inductor current iL may drop to zero, but would not remain at zero or go negative. In other words, the inductor current iL operates at a boundary conduction mode between continuous and discontinuous conduction modes.

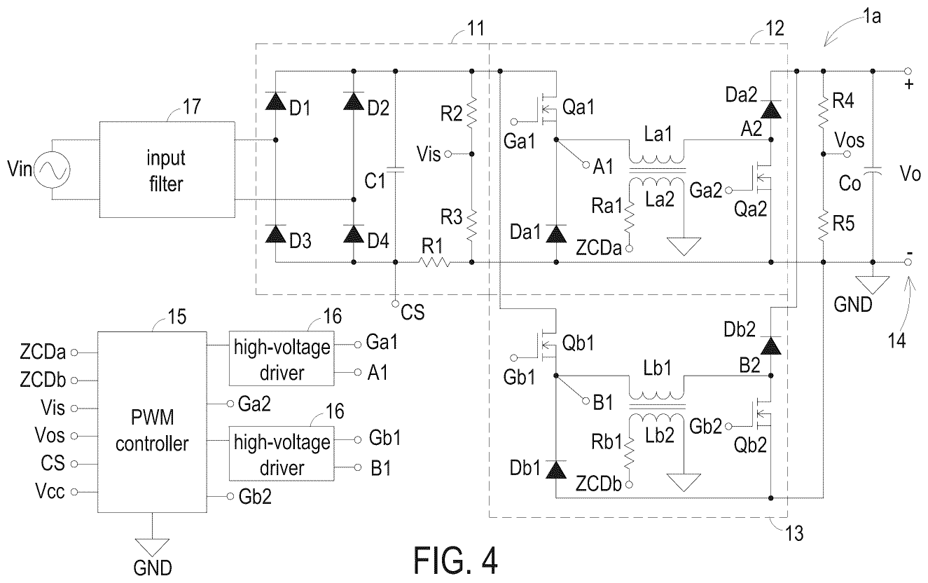

Please refer to FIG. 4. FIG. 4 is a schematic circuit diagram illustrating an interleaved buck-boost PFC circuit according to another embodiment of the present disclosure. In FIG. 4, the component parts and elements corresponding to those of FIG. 1 are designated by identical numeral references, and detailed descriptions thereof are omitted herein. As shown in FIG. 4, in an embodiment, the rectifier module 11 includes diodes D1, D2, D3, D4, a capacitor C1, and resistors R1, R2 and R3. The diodes D1 and D3 are electrically connected in series with a connection node therebetween coupled to the input filter 17, and form a first diode bridge. The diodes D2 and D4 are electrically connected in series with a connection node therebetween coupled to the input filter 17, and form a second diode bridge. The resistors R2, R3 and R1 are electrically connected in series sequentially and form a resistor bridge, and a connection node between the resistors R3 and R1 is further connected to the ground terminal GND. The first and second diode bridges, the resistor bridge, and the capacitor C1 are electrically connected in parallel.

In an embodiment, the interleaved buck-boost PFC circuit 1a further includes resistors R4 and R5. The resistors R4 and R5 are serially connected to form a resistor bridge electrically coupled to the output capacitor Co in parallel.

In an embodiment, in order to monitor and control the operation of the interleaved buck-boost PFC circuit 1a, the PWM controller 15 samples voltages Vis and Vos, and the PWM controller 15 includes a port coupled to a current sense terminal CS for receiving a sensing current. The current sense terminal CS is electrically connected to the rectifier module 11, and the sensing current reflects the current flowing through the rectifier module 11. The sensing current and the voltages Vis and Vos may be used in control loop, such as current loop and voltage loop, for controlling the operation of the interleaved buck-boost PFC circuit 1a.

In addition, in an embodiment, the PWM controller 15 samples inductor currents flowing through the inductors La1 and Lb1 respectively so as to detect the zero-crossing point of the inductor currents. In another embodiment, as shown in FIG. 4, the PWM controller 15 realizes the zero-crossing detection through detecting a current flowing through another inductor coupled with the inductor La1 or Lb1. In particular, the converter circuit 12 further includes an inductor La2 and a resistor Ra1. The inductor La2 is coupled with the inductor La1, two terminals of the inductor La2 are electrically connected to the ground terminal GND and a first terminal of the resistor Ra1, and a second terminal of the resistor Ra1 is connected to a node ZCDa. The PWM controller 15 includes a port connected to the node ZCDa so that the zero-crossing detection may be realized by detecting a current flowing through the resistor Ra1 and inductor La2. Similarly, the converter circuit 13 further includes an inductor Lb2 and a resistor Rb1. The inductor Lb2 is coupled with the inductor Lb1, two terminals of the inductor Lb2 are electrically connected to the ground terminal GND and a first terminal of the resistor Rb1, and a second terminal of the resistor Rb1 is connected to a node ZCDb. The PWM controller 15 includes a port connected to the node ZCDb so that the zero-crossing detection may be realized by detecting a current flowing through the resistor Rb1 and inductor Lb2.

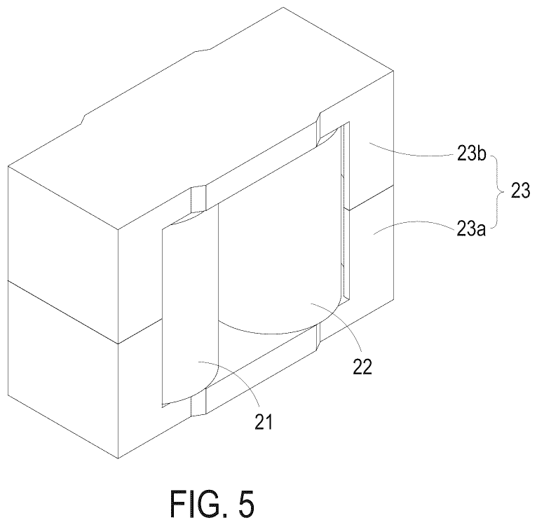

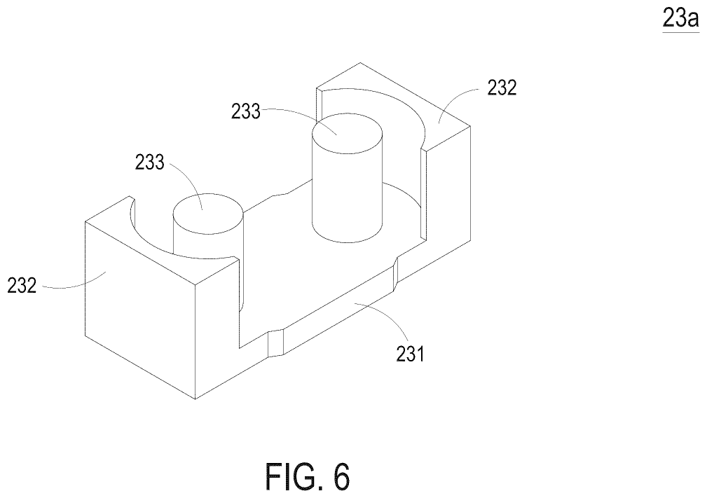

Please refer to FIG. 5. FIG. 5 is a schematic perspective view illustrating the inductors La1 and Lb1 of the two converter circuits 12 and 13 of FIG. 1. In an embodiment, as shown in FIG. 5, the inductors La1 and Lb1 are formed by a first winding 21 and a second winding 22 respectively, and the first winding 21 and the second winding 22 are wound on the same magnetic core 23. In addition, the first winding 21 and the second winding 22 have the same polarity, namely, currents flowing through the first winding 21 and the second winding 22 are in the same direction. The magnetic fields in inductors La1 and Lb1 have the same reference direction. In an embodiment, the magnetic core 23 includes a first component 23a and a second component 23b assembled to each other and having the same structure. The structure of the first component 23a is exemplified in FIG. 6. Please refer to FIG. 6 in conjunction with FIG. 5. The first component 23a includes a plate 231, two side pillars 232, and two winding pillars 233. The two side pillars 232 and the two winding pillars 233 are disposed on the plate 231, and the winding pillars 233 are located between the two side pillars 232. Additionally, on each of the winding pillars where the first winding 21 and the second winding 22 are wound, there may be one or more air gaps. Moreover, when there are plural air gaps on each winding pillar, the loss caused by leakage flux through the windings is reduced.

In traditional Buck-Boost PFC design, the first switch Qa1 is turned on/off and the second switch Qa2 is turned off in buck mode, or the first switch Qa1 is turned on and the second switch Qa2 is turned on/off in boost mode. The complex control methods can only be achieved by using MCU (microcontroller unit). The present invention is controlled in buck and boost mode in which the first switch Qa1 and the second switch Qq2 are turned on and off at the same time. The control mode is simple and can be achieved by using a general analog IC.

In summary, the present disclosure provides an interleaved buck-boost PFC circuit in which the circuit topology and control architecture are simple, thereby reducing costs and making the interleaved buck-boost PFC circuit easy to implement. Moreover, the low output voltage, resulting from the interleaving characteristics, allows the subsequent circuits to adopt switching devices with regular withstand voltage (e.g., 600V), thereby reducing costs and achieving high efficiency.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interleaved buck-boost PFC (power factor correction) circuit, comprising:
a rectifier module, configured to receive an AC input voltage;
two converter circuits, electrically connected in parallel between the rectifier module and an output port of the interleaved buck-boost PFC circuit, wherein a DC output voltage at the output port is lower than a peak value of the AC input voltage, and each of the two converter circuits comprises:
a first switch and a first diode, electrically connected in series and coupled to the rectifier module;
a second switch and a second diode, electrically connected in series and coupled to the output port, wherein the first diode and the second switch are further coupled to a ground terminal; and
an inductor, electrically connected between a connection node of the first switch and the first diode and a connection node of the second switch and the second diode; and
a PWM (pulse width modulation) controller and a high-voltage driver, wherein for each of the two converter circuits, the PWM controller provides a first control signal to the first switch through the high-voltage driver and provides a second control signal to the second switch directly,
wherein the first switch and the second switch in each of the two converter circuits are turned on and off simultaneously, and two said first control signals of two said first switches of the two converter circuits interleave at least partially.

2. The interleaved buck-boost PFC circuit according to claim 1, wherein the two first control signals of the two first switches of the two converter circuits are complementary to each other.

3. The interleaved buck-boost PFC circuit according to claim 1, wherein the two first control signals of the two first switches of the two converter circuits have a phase difference in a range of 45 degrees to 135 degrees.

4. The interleaved buck-boost PFC circuit according to claim 1, wherein the two converter circuits are buck-boost converters, and the first switch and the second switch in each of the two converter circuits are turned on and off simultaneously in buck and boost mode.

5. The interleaved buck-boost PFC circuit according to claim 4, wherein in each of the two converter circuits, the first switch, the first diode and the inductor form a buck configuration, and the second diode, the second switch and the inductor form a boost configuration.

6. The interleaved buck-boost PFC circuit according to claim 1, wherein in each of the two converter circuits, an inductor current flowing through the inductor operates at a boundary conduction mode between continuous and discontinuous conduction modes.

7. The interleaved buck-boost PFC circuit according to claim 1, wherein the PWM controller comprises a PWM integrated circuit, and the high-voltage driver comprises a high-voltage driving integrated circuit which provides voltage isolation.

8. The interleaved buck-boost PFC circuit according to claim 1, wherein the first switch and the second switch of each of the two converter circuits are metal-oxide-semiconductor field-effect transistors.

9. The interleaved buck-boost PFC circuit according to claim 1, wherein two said inductors of the two converter circuits are formed by two windings wound on one magnetic core.

10. The interleaved buck-boost PFC circuit according to claim 9, wherein currents flowing through the two windings are in the same direction.

11. The interleaved buck-boost PFC circuit according to claim 9, wherein the magnetic core comprises two winding pillars, the two windings are wound on the two winding pillars respectively, and each of the two winding pillars has one or more air gaps.

12. The interleaved buck-boost PFC circuit according to claim 1, wherein the AC input voltage is higher than 300 Vac.

13. The interleaved buck-boost PFC circuit according to claim 1, wherein the PWM controller comprises a port coupled to a current sense terminal for receiving a sensing current, the current sense terminal is electrically connected to the rectifier module, and the sensing current reflects the current flowing through the rectifier module.

14. The interleaved buck-boost PFC circuit according to claim 1, wherein each of the two converter circuits further comprises another inductor coupled with the inductor, and the PWM controller comprises a port connected to the another inductor to detect a current flowing through the another inductor for zero-crossing detection.

15. The interleaved buck-boost PFC circuit according to claim 1, wherein voltage values of the two first control signals are the same.

16. The interleaved buck-boost PFC circuit according to claim 1, wherein in each of the two converter circuits, voltage values of the first control signal and the second control signal are the same and a phase difference between the first control signal and the second control signal is 180 degrees.
